(19) United States
(12) Patent Application Publication
(10) Pub. No.: US 2024/0047703 A1
(43) Pub. Date: Feb. 8, 2024

(54) LAYER AND LAYER SYSTEM AND ELECTRICALLY CONDUCTIVE PLATE AND ELECTROCHEMICAL CELL

(71) Applicant: Schaeffler Technologies AG & Co. KG, Herzogenaurach (DE)

(72) Inventors: Romina BAECHSTAEDT, Wooster, OH (US); Moritz WEGENER, Erlangen (DE); Jan Martin STUMPF, Erlangen (DE); Edgar SCHULZ, Langensendelbach (DE); Ricardo Henrique BRUGNARA, Hessdorf (DE); Joachim WEBER, Erlangen (DE)

(73) Assignee: Schaeffler Technologies AG & Co. KG, Herzogenaurach (DE)

(21) Appl. No.: 18/267,535

(22) PCT Filed: Nov. 26, 2021
(86) PCT No.: PCT/DE2021/100936

§ 371 Date: Jun. 15, 2023

(30) Foreign Application Priority Data
Dec. 16, 2020 (DE) 102020133766.3
Nov. 25, 2021 (DE) 102021130935.2

(51) Int. Cl. H01M 8/0228; C25B 1/04; C25B 9/60; C25B 9/75; H01M 8/18; C25B 9/77

(52) U.S. Cl. CPC H01M 8/0228; C25B 1/04; C25B 9/60; C25B 9/75; H01M 8/188; C25B 9/77

(57) ABSTRACT

A layer, in particular for forming an electrically conductive plate for an electrochemical cell, wherein the layer contains a first chemical element from the group of precious metals in the form of ruthenium in a concentration in the range of 50 to 99 at. % and at least a second chemical element in the form of silicon in a concentration of <10 at. %. Furthermore, a layer system, an electrically conductive plate and an electrochemical cell are provided.

### CROSS-REFERENCE TO RELATED APPLICATIONS

This application is the U.S. National Phase of PCT Appln. No. PCT/EP2021/100936, filed Nov. 26, 2021, which claims priority from German Patent Application No. 10 2020 133 766.3, filed Dec. 16, 2020 and German Patent Application N0. 10 2021 130 935.2, filed Nov. 25, 2021, the entire disclosures of which are incorporated by reference herein.

### TECHNICAL FIELD

The disclosure relates to a layer, in particular for forming an electrically conductive plate for an electrochemical cell. Furthermore, the disclosure relates to a layer system having such a layer and an electrically conductive plate having such a layer system. The disclosure also relates to an electrochemical cell, in particular a fuel cell, an electrolyzer or a redox flow cell, having at least one such electrically conductive plate.

### BACKGROUND

Electrochemical systems such as fuel cells, in particular polymer electrolyte fuel cells, and electrically conductive, current-collecting plates for such fuel cells and electrolyzers, as well as current collectors in galvanic cells and electrolyzers, are known.

An example of this are the bipolar or monopolar plates in fuel cells, especially in an oxygen half-cell. The bipolar or monopolar plates are in the form of carbon plates (e.g., graphoil plates), which contain carbon as an essential component. These plates tend to be brittle and are comparatively thick, so that they significantly reduce the power volume of the fuel cell. Another disadvantage is their lack of physical (e.g., thermomechanical) and/or chemical and/or electrical stability.

Also known is the production of the current collecting plates of the fuel cell from metallic (in particular austenitic) stainless steels. The advantage of these plates is that a plate thickness of less than 0.5 mm can be achieved. This thickness is desirable so that both the space and the weight of the fuel cell can be kept as small as possible. The problem with these plates is that surface oxides are formed during operation of the fuel cell, so that a surface resistance is impermissibly increased and/or electrochemical decomposition (such as corrosion) occurs.

Published Patent Applications DE 10 2010 026 330 A1, DE 10 2013 209 918 A1, DE 11 2005 001 704 T5 and DE 11 2008 003 275 T5 describe the coating of austenitic stainless steels as carriers to achieve the requirement, for example, for the use of bipolar plates in fuel cells having a gold layer, which is in a band area of up to 2 nm. There are several disadvantages to this solution to the requirement. For example, a gold layer, even if only 2 nm thick, is still too expensive for mass applications. A much greater disadvantage can be seen in a basic property of the chemical element gold. Gold is more precious than stainless austenitic steel (stainless steel) as a carrier material and under unfavorable operating conditions in the fuel cells causes the carrier to dissolve (e.g., pitting or pitting corrosion), which results in a reduction in service life. Corrosion cannot be prevented, particularly in environments containing chloride (e.g., aerosols).

In particular, another disadvantage is that gold is not stable for high-load applications, for example at electrolysis conditions above 1500 mV vs. standard hydrogen unit, in either an acidic or basic environment.

Layers on the carrier in the form of what are termed hard material layers based on nitride or carbide are also known from the prior art. An example of this is titanium nitride, which, however, tends to form oxidic metal complexes through to closed surface layers during operation of a fuel cell. As a result, the surface resistance increases to high values, as with stainless steel. Processes for coating with chromium nitride or chromium carbonitride can be found, for example, in the patent specifications DE 199 37 255 B4 and EP 1273060 B1 and the published patent application DE 100 17 200 A1.

Depending on the composition, the hard material layers have very good operating properties (e.g., resistance to corrosion, abrasion resistance, high contour accuracy), but they harbor the risk of anodic dissolution if concentration chains form in the fuel cell under unfavorable operating conditions. This anodic dissolution occurs when what is termed a local element or an unexpected and undesired reaction element occurs during internal electrochemical short circuits in the fuel cell, such as the formation of a water film between an active electrode of a membrane electrode assembly of the fuel cell and the bipolar plate.

Also known are multiple coatings based on nitrides having very thin layers of gold or platinum. Thus, satisfactory operating results for a fuel cell can be achieved with layer thicknesses of the precious metals of more than 2 μm. The fundamental problem of dissolution remains at high anodic potentials. The layer thickness ensures an almost pore-free top layer and thus reduces the risk of pitting corrosion.

What are termed dimensionally stable anodes are also known. Here, single-phase or multi-phase oxides with ruthenium oxide and/or iridium oxide are formed with the aid of refractory metals. Although this type of layer is very stable, the electrical resistance is too high. The same is also true when a surface of the carrier, generally made of a precious metal, is doped with iridium.

DE 10 2009 010 279 A1 describes a bipolar fuel cell plate comprising a conductive metal plate which is anodized and on which a conductive layer is subsequently deposited by means of an atomic layer deposition process. In particular, the conductive layer comprises at least one of titanium oxynitride, gold, platinum, carbon, ruthenium or ruthenium oxide.

DE 10 2016 202 372 A1 discloses a layer consisting of a homogeneous or heterogeneous solid metallic solution or composite containing a first chemical element from the group of precious metals in the form of iridium and/or a second chemical element from the group of precious metals in the form of ruthenium and at least one other non-metallic chemical element from the group consisting of nitrogen, carbon, boron, fluorine and hydrogen.

The following requirements must therefore be placed on the metallic carriers or a bipolar plate for a PEM fuel cell or an electrolyzer designed in these electrochemical systems, in particular for energy conversion:
high corrosion resistance to a surrounding medium, and/or
high resilience to anodic or cathodic polarizing loads,
low surface resistance of an electrolyte-facing surface of the carrier or its coating, and
low production costs of the carrier, in particular, for example, an electrically conductive conductor in the form of bipolar plates for the use of fuel cells for mobile use.

WO 2018/145 720 A1 discloses a plate-shaped electrode made of composite material for a redox flow cell, which is structured for optimal distribution of fluid.

### SUMMARY

It is therefore the object of the present disclosure to provide an improved layer or an improved layer system in general for an energy converter, in particular for a bipolar plate of a fuel cell or an electrolyzer or an electrode of a redox flow cell. Furthermore, it is the object of the disclosure to specify an electrically conductive plate having an improved layer system and an electrochemical cell equipped therewith.

The object is achieved according to the disclosure by a layer, in particular for forming an electrically conductive plate for an electrochemical cell, wherein the layer contains a first chemical element from the group of precious metals in the form of ruthenium in a concentration in the range from 50 to 99 at. % and at least one second chemical element in the form of silicon in a concentration of <10 at. %.

Silicon forms stable composites, especially oxides, which have a positive effect on the resistance of the layer to electrochemical attack.

The silicon is preferably contained in a concentration in the range from 3 to <10 at. %.

The object is also achieved according to the disclosure by a layer system, in particular for an electrically conductive plate of an electrochemical cell, comprising a cover layer and an undercoat layer system, the cover layer being designed in the form of the layer according to the disclosure.

The object is also achieved according to the disclosure by an electrochemical cell, in particular in the form of a fuel cell, an electrolyzer or a redox flow cell, comprising at least one electrically conductive plate according to the disclosure.

Advantageous configurations with expedient and non-trivial developments according to the disclosure are specified below and in the claims.

The layer according to the disclosure is electrically conductive and electrocatalytically active and designed to protect against corrosion.

The layer according to the disclosure preferably contains at least one further second chemical element from the group consisting of nitrogen, carbon, boron, fluorine, hydrogen, and oxygen.

The iridium and/or the ruthenium is preferably present in the cover layer in a concentration in the range from 1 at. % to 40 at. %.

The at least one second chemical element is preferably dissolved in the metal lattice of the ruthenium in such a way that the lattice type of the host metal or the host metal alloy essentially does not change.

The layer according to the disclosure preferably comprises:
a) ruthenium, silicon, and carbon; or
b) ruthenium, silicon, carbon, and hydrogen; or
c) ruthenium, silicon, carbon, and fluorine, optionally also hydrogen; or
d) ruthenium, silicon, carbon and oxygen; or
e) ruthenium, silicon, carbon, oxygen, and hydrogen.

It has been shown that with a carbon-containing layer, i.e., through the use of the metalloid or non-metallic chemical element carbon, the conductivity of the layer is higher than with gold, and that at the same time its oxidative stability in an acidic solution is significantly above a voltage of 2000 mV vs. standard hydrogen electrode. Depending on the embodiment, measured specific electrical resistances are below 5 mΩ cm⁻² (under standardized conditions).

In comparison, the specific electrical resistance of gold is approx. 10 mΩ cm⁻² at room temperature.

The layer preferably also has at least one chemical element from the group of refractory metals, in particular titanium and/or zirconium and/or hafnium and/or niobium and/or tantalum and/or tungsten. The at least one chemical element from the group of refractory metals is contained in the layer in particular in a concentration range of 0.01 to 10 at. %. It has been shown that the addition of the refractory metals also partially controls the H₂O₂ and ozone formed during the electrolysis.

The layer preferably also contains at least one chemical element from the group of base metals. The at least one chemical element from the group of base metals is preferably formed by aluminum, iron, nickel, cobalt, zinc, cerium, tin. The at least one further chemical element from the group of base metals is contained in the layer, in particular in a concentration range of 0.01 to 10 at. %.

The at least one chemical element from the group of base metals in the form of tin and the at least one chemical element from the group of refractory metals together are contained in the layer in particular in a concentration range of 0.01 to 10 at. %.

The layer also preferably has at least one additional chemical element from the group comprising iridium, platinum, gold, silver, rhodium, palladium in a concentration range of 0.01 to 25 at. %.

It is preferable if the layer has a layer thickness in the range from 0.5 to 500 nm.

It has proven useful if all chemical elements from the group of precious metals, i.e., together with ruthenium, are contained in the layer in a concentration range of >50 to 99 at. %.

The corrosion protection on metallic substrates, such as those made of steel, in particular high-grade steel, or titanium, is further improved by applying the layer according to the disclosure to an underlayer system formed between the substrate and the layer. This is particularly advantageous when corrosive media are present, especially when the corrosive media contain chloride.

An under-oxidation, i.e., an oxidation of the surface of a support with a layer applied to this surface, normally leads to the delamination of precious metal layers lying thereon.

The object is also achieved by a layer system, in particular for an electrically conductive plate of an electrochemical cell, comprising a cover layer and an undercoat layer system, the cover layer being in the form of the layer according to the disclosure.

In particular, the undercoat layer system comprises at least one undercoat layer which has at least one chemical element from the group titanium, niobium, hafnium, zirconium, tantalum.

The undercoat layer system has in particular a first undercoat layer in the form of a metallic alloy layer comprising the chemical elements titanium and niobium, in particular 20-50 wt. % niobium and the remainder titanium.

The undercoat layer system has in particular a second undercoat layer comprising at least one chemical element from the group titanium, niobium, zirconium, hafnium, tantalum, and also at least one non-metallic element from the group nitrogen, carbon, boron, fluorine.

In a particularly preferred embodiment, the undercoat layer system has a second undercoat layer comprising the chemical elements:
a) titanium, niobium and also carbon and fluorine, or
b) titanium, niobium and also nitrogen, is formed in particular from (Ti₆₇Nb₃₃)N_{0.8-1.1}.

The second undercoat layer is preferably positioned between the first undercoat layer and the top layer.

The second undercoat layer can further contain up to 5 at. % oxygen.

Advantageously, a thickness of the layer or cover layer according to the disclosure of less than 10 nm is sufficient to protect against resistance-increasing oxidation of the second undercoat layer. In order to provide reliable protection against corrosion, partial layers of the undercoat layer system are made of at least one refractory metal, which are applied in at least two layers to the steel, in particular stainless steel, first as a metal or alloy layer (=first undercoat layer) and then as a metalloid layer (=second undercoat layer). The double layer formed with the help of the two-layer structure under the layer according to the disclosure ensures on the one hand an electrochemical adaptation to a substrate material, i.e., the material from which the substrate for receiving the layer system is formed, and on the other hand pore formation due to oxidation and hydrolysis processes is excluded.

Electrochemical adaptation to the substrate material is necessary because both the metalloid layer (=second undercoat layer) and the layer according to the disclosure or the top layer are very precious. In the event of pore formation, high local element potentials would build up, resulting in impermissible corrosion currents. The metallic first undercoat layer is preferably formed from titanium or niobium or zirconium or tantalum or hafnium or from alloys of these metals, which are less precious than the substrate material in the form of steel, in particular stainless steel, and initially react with corrosion processes to form insoluble oxides or voluminous sometimes gel-like hydroxo composites of these refractory metals. As a result, the pores become blocked and protect the base material from corrosion. The process represents a self-healing of the layer system.

In particular, a second undercoat layer in the form of a nitride layer serves as a hydrogen barrier and thus protects the substrate, in particular made of stainless steel, the bipolar plate, and the metallic first undercoat layer from hydrogen embrittlement.

The object is also achieved by an electrically conductive plate, in particular a bipolar plate of a fuel cell or an electrolyzer or an electrode of a redox flow cell, having a metallic substrate and a layer system according to the disclosure applied at least in partial areas of the surface of the substrate.

In particular, the layer system is applied over the full area to one or both sides of the substrate. The metallic substrate is formed in particular from steel or titanium, preferably from high-grade steel. A thickness of the substrate is preferably less than 1 mm and is in particular equal to 0.5 mm.

Finally, the object is achieved by an electrochemical cell, in particular in the form of a fuel cell, an electrolyzer, or a redox flow cell, comprising at least one electrically conductive plate according to the disclosure.

A fuel cell according to the disclosure, in particular a polymer electrolyte fuel cell, comprising at least one electrically conductive plate according to the disclosure in the form of a bipolar plate, has proven to be particularly advantageous in terms of electrical values and corrosion resistance. Such a fuel cell therefore has a long service life of more than 10 years or more than 5000 motor vehicle operating hours.

Comparably long service lives can be achieved with an electrolyzer according to the disclosure, which works with the opposite principle of action with regard to a fuel cell and brings about a chemical reaction, i.e., a material conversion, with the aid of electric current. In particular, the electrolyzer is one that is suitable for hydrogen electrolysis.

With a redox flow cell according to the disclosure comprising at least one electrically conductive plate according to the disclosure in the form of an electrode, long service lives, and power densities can be achieved.

### BRIEF DESCRIPTION OF THE DRAWINGS

Further features, advantages and details of the disclosure will be apparent from the following description of preferred exemplary embodiments. The features and combinations of features mentioned above in the description can be used not only in the combination specified in each case, but also in other combinations or on their own, without departing from the scope of the disclosure.

In the figures:

FIG. 1 shows an electrically conductive plate in a sectional view,

FIG. 2 shows an electrode with a flux field,

FIG. 3 shows a redox flow cell or a redox flow battery having a redox flow cell,

FIG. 4 shows an electrolyzer in a sectional view, and

FIG. 5 shows a fuel cell stack in a three-dimensional view.

### DETAILED DESCRIPTION

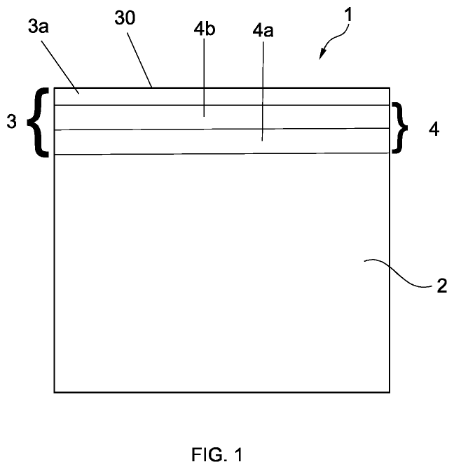

FIG. 1 shows an electrically conductive plate 1 in a sectional view, comprising a substrate 2 made of stainless steel and a layer system 3 applied over the entire surface on one side of the substrate 2. The layer system 3 comprises a cover layer 3a and an undercoat layer system 4 comprising a first undercoat layer 4a and a second undercoat layer 4b.

In a first exemplary embodiment, a metallic substrate 2 in the form of a conductor, here for a bipolar plate of a polymer electrolyte fuel cell for converting (reformed) hydrogen, is made of stainless steel, in particular of what is termed an authentic steel with very high, known requirements for corrosion resistance, e.g., DIN ISO material number 1.4404.

The layer system 3 is formed on the substrate 2 by means of a coating process, for example a vacuum-based coating process (PVD), with the substrate 2 in one process step initially being coated with a first undercoat layer 4a in the form of a 1.5 μm thick titanium layer, then with an approximately equal thickness thick second undercoat layer 4b in the form of a titanium nitride layer, and finally with a top layer 3a having the composition RuSiC. The cover layer 3a corresponds to a layer coating that is open on one side, since only one cover layer surface of a further layer, here the second undercoat layer 4b, is designed to make contact therewith. Thus, the free surface 30 of the cover layer 3a in a fuel cell is arranged to be facing an electrolyte, in particular a polymer electrolyte.

In a second exemplary embodiment, the metallic substrate 2 is initially coated with a first undercoat layer 4a in the form of a metallic alloy layer with a thickness of several 100 nm, the metallic alloy layer having the composition Ti_{0.9}Nb_{0.1}. A further application of a second undercoat layer 4b then takes place with a thickness of a further several hundred nm of the composition Ti_{0.9}Nb_{0.1}N₁₋ₓ. A cover layer 3a with a thickness of several nm in the composition RuSiC is then applied.

The advantage is an exceptionally high stability against oxidation of the plate 1 according to the i disclosure. Even with a permanent load of +3000 mV vs. standard hydrogen electrode, no increase in resistance is found in a sulfuric acid solution, which has a pH value of 3.

The cover layer 3a according to the disclosure of the first and second exemplary embodiment can be applied both by means of the sputtering technique and by means of a cathodic ARC coating method, also known as vacuum arc evaporation. Despite a higher number of droplets, in other words, an increased number of metal droplets compared to sputtering technology, the cover layer 3a according to the disclosure produced in the cathodic ARC process also has the advantageous properties of high corrosion resistance with surface conductivity that is stable over time, of the cover layer 3a according to the disclosure produced using sputtering technology.

In a third exemplary embodiment, the layer system 3 according to the disclosure is formed on a substrate 2 in the form of a structured perforated stainless steel sheet. The substrate 2 has been electrolytically polished in an H₂SO₄/H₃PO₄ bath before a layer system 3 is applied. After the application of a single undercoat layer in the form of a tantalum carbide layer several thousands of nm thick, a cover layer 3a in the form of RuSiCHO is applied.

The advantage of the undercoat layer formed from tantalum carbide consists not only in its extraordinary resistance to corrosion but also in the fact that it does not absorb any hydrogen and thus serves as a hydrogen barrier for the substrate 2. This is particularly advantageous if titanium is used as the substrate material.

The layer system 3 according to the disclosure of the third exemplary embodiment is suitable for use in an electrolytic cell for generating hydrogen at current densities i that are greater than 500 mA cm⁻².

The advantage of the metalloid layer lying in between and/or closed on both sides in the layer system or of the second undercoat layer, which in the simplest case is formed from titanium nitride, for example, is its low electrical resistance of 10-12 mΩ cm⁻². Likewise, the layer or cover layer according to the disclosure can also be formed without a second undercoat layer or metalloid layer, with a possible increase in resistance.

Table 1 shows some coating systems with their characteristic values.

TABLE 1
Layers and selected characteristic values

| | | | Corrosion current at | Oxidative |
|---|---|---|---|---|
| | | | 2000 mV vs. standard | stability |
| | | | hydrogen electrode | 2000 mV |
| | | | in μA cm⁻² in | measured as |
| | Layer | | aqueous sulfuric | change of |
| | system/layer | Surface | acidic solution | surface resistance |
| | thickness | resistivity | (pH3) at T = 70° C. | in mΩ cm⁻² |
| 1 | Gold/3 μm | 9 | >100 pitting current | 9-10 |
| | (for reference) | | | |
| 2 | Ti/0.5 μm | 5 | 70-80 | 18-9 |
| | TiN/1 μm | | | |
| | RuSiC/5 nm | | | |
| 3 | TiNb/0.5 μm | 5 | 40-60 | 8-9 |
| | TiNbN/1 μm | | | |
| | RuSiC /10 nm | | | |

Table 1 shows only a few exemplary layer systems. Advantageously, the layer systems according to the disclosure show no increase in resistance over several weeks at an anodic load of +2000 mV vs. standard hydrogen electrode in sulfuric acid solution at a temperature with a value of 70-80° C. The layer systems applied in a high vacuum using a sputtering or ARC method or in a fine vacuum using a PECVD method (plasma-enhanced chemical vapor deposition method) were partially darkened after this exposure time. However, there were no visible signs of corrosion or significant changes in surface resistance.

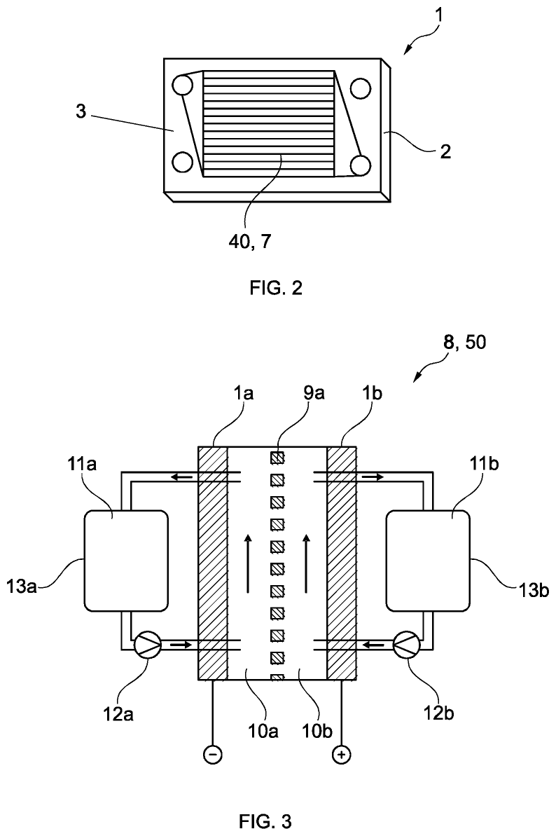

FIG. 2 shows a three-dimensional view of a plate 1 in the form of an electrode, comprising a substrate 2 in the form of a metal sheet made of stainless steel with a profiling 40, which forms a flux field 7. In the substrate 2 there is a profiling 40 on both sides for forming a flux field 7 in each case, resulting in a three-dimensional structuring of the surface of the electrode. The substrate 2 is covered on both sides with a layer system 3, onto which an electrolyte is to flow in a redox flow cell 8 (cf. FIG. 3).

FIG. 3 shows an electrochemical cell 50 in the form of a redox flow cell 8 or a redox flow battery with a redox flow cell 8. The redox flow cell 8 comprises two plates 1a, 1b in the form of electrodes, a first reaction chamber 10a and a second reaction chamber 10b, wherein each reaction chamber 10a, 10b is in contact with one of the electrodes. The reaction chambers 10a, 10b are separated from one another by an ion exchange membrane 9a. A liquid anolyte 11a is pumped from a tank 13a into the first reaction chamber 10a via a pump 12a and is fed through between the electrode unit 1a and the ion exchange membrane 9a. A liquid catholyte 11b is pumped from a tank 13b into the second reaction chamber 10b via a pump 12b and is fed through between the electrode unit 1b and the ion exchange membrane 9a. Ion exchange occurs across the ion exchange membrane 9a, wherein electrical energy is released due to the redox reaction at the electrodes.

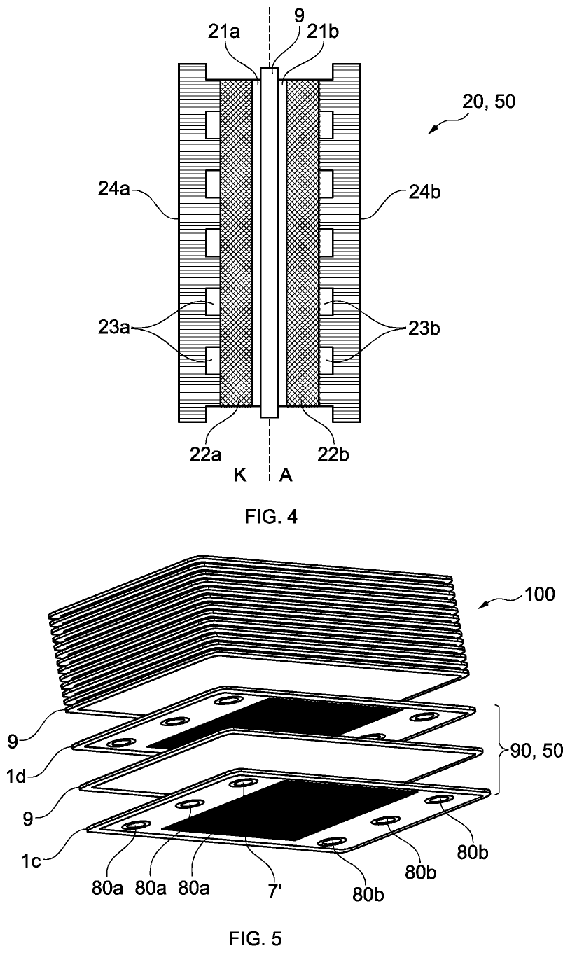

FIG. 4 shows an electrochemical cell 50 in the form of an electrolysis cell 20 of an electrolyzer comprising a polymer electrolyte membrane 9 which separates an anode side A and a cathode side K from one another. A catalyst layer 21a, 21b, each comprising a catalyst material and a fluid diffusion layer 22a, 22b, is arranged adjacent to the catalyst layer 21a, 21b on both sides of the polymer electrolyte membrane 9. The fluid diffusion layers 22a, 22b are each disposed to be adjacent to an electrically conductive plate 24a, 24b, with the fluid diffusion layers 22a and 22b being formed of expanded metal. The plates 24a, 24b each have flow channels 23a, 23b on their sides facing the fluid diffusion layers 22a, 22b in order to improve the supply of reaction medium (water) and the removal of reaction products (water, hydrogen, oxygen).

FIG. 5 schematically shows a fuel cell stack 100 comprising a plurality of electrochemical cells 50 in the form of fuel cells 90. Each fuel cell 90 comprises a polymer electrolyte membrane 9 adjacent to both sides of plates 1c, 1d in the form of bipolar plates. Each bipolar plate has a substrate 2 made of stainless steel, which is covered on both sides with a layer system 3 (see FIG. 1). The bipolar plate has an inflow area with openings 80a and an outlet area with further openings 80b, which are used to supply a fuel cell 90 with process gases and coolant and to remove reaction products from the fuel cell 90 and coolant. The bipolar plate also has a gas distribution structure 7′ on each side, which is arranged to be facing the polymer electrolyte membrane 9.

### LIST OF REFERENCE SYMBOLS

1, 1a, 1b, 1c, 1d,
24a, 24b Electrically conductive plate
2 Substrate
3 Layer system
3a Layer, cover layer
4 Undercoat layer system
4a First undercoat layer
4b Second undercoat layer
7 Flux field
7′ Gas distribution structure
8 Redox flow cell
9 Polymer electrolyte membrane
9a Ion exchange membrane
10a First reaction chamber
10b Second reaction chamber
11a Anolyte
11b Catholyte
12a, 12b Pump
13a, 13b Tank
20 Electrolytic cell
21a, 21b Catalyst layer
22a, 22b Fluid diffusion layer
23a, 23b Flow duct
30 Free surface
40 Profiling
50 Electrochemical cell
80a, 80b Opening
90 Fuel cell
100 Fuel cell stack
K Cathode side
A Anode side

1. A layer for forming an electrically conductive plate for an electrochemical cell, the layer comprising:
a first chemical element from the group of precious metals including ruthenium in a concentration in a range from 50 to 99 at. %; and
at least one second chemical element including silicon in a concentration of <10 at. %.

2. The layer according to claim 1, further comprising at least one further second chemical element from the group comprising nitrogen, carbon, boron, fluorine, hydrogen and oxygen.

3. The layer according to claim 2, wherein the at least one further second chemical element is present in the layer in a concentration in a range from 1 at. % to 40 at. %.

4. The layer according to claim 1, wherein the layer comprises one of:
a) the ruthenium, the silicon and carbon;
b) the ruthenium, the silicon, carbon and hydrogen;
c) the ruthenium, the silicon, carbon and fluorine;
d) the ruthenium, the silicon, carbon, and oxygen; or
e) the ruthenium, the silicon, carbon, oxygen, and hydrogen.

5. The layer according to claim 1, wherein the layer further comprises at least one chemical element from the group of refractory metals.

6. The layer according to claim 5, wherein the at least one chemical element from the group of refractory metals is contained in the layer in a concentration range of 0.01 to 10 at. %.

7. The layer according to claim 1, wherein the layer further contains at least one chemical element from the group of base metals.

8. The layer according to claim 7, wherein the at least one chemical element is from the group of base metals aluminum, iron, nickel, cobalt, zinc, cerium and tin.

9. The layer according to claim 7, wherein the at least one further chemical element from the group of base metals is contained in the layer in a concentration range of 0.01 to 10 at. %.

10. The layer according to claim 7, wherein the layer further comprises at least one chemical element from the group of refractory metals, the at least one chemical element from the group of base metals includes tin, and the at least one chemical element from the group of refractory metals are contained together in the concentration range of 0.01 to 10 at. % in the layer.

11. The layer according to claim 1, wherein the layer further comprises at least one additional chemical element from the group comprising iridium, platinum, gold, silver, rhodium and palladium in a concentration range of 0.01 to 25 at. %.

12. The layer (3a) according to claim 1, wherein the layer has a layer thickness in a range of 0.5 nm to 500 nm.

13. A layer system for an electrically conductive plate of an electrochemical cell, the layer system comprising:
the cover layer according to claim 1 and an undercoat layer system.

14. The layer system according to claim 13, wherein the undercoat layer system comprises at least one undercoat layer comprising at least one chemical element from the group titanium, niobium, hafnium, zirconium and tantalum.

15. The layer system according to claim 14, wherein the undercoat layer system comprises at least one first undercoat layer including a metallic alloy layer comprising the chemical elements titanium and niobium.

16. The layer system according to claim 15, wherein the undercoat layer system comprises a second undercoat layer comprising at least one chemical element from the group titanium, niobium, hafnium, zirconium, tantalum, and at least one non-metallic element from the group nitrogen, carbon, boron and fluorine.

17. The layer system according to claim 16, wherein the second undercoat layer is arranged between the first undercoat layer and the cover layer.

18. The layer system according to claim 16, wherein the second undercoat layer contains up to 5 at. % oxygen.

19. An electrically conductive plate of a fuel cell or an electrolyzer or an electrode of a redox flow cell, the electrically conductive plate comprising a metallic substrate and the layer system according to claim 13 applied at least in partial areas of a surface of the substrate.

20. An electrochemical cell comprising at least one of the electrically conductive plates according to claim 19.

21. The electrochemical cell according to claim 20, wherein the electrochemical cell is a fuel cell and the plate comprises a bipolar plate.

22. The electrochemical cell according to claim 20, wherein the electrochemical cell is an electrolyzer the plate comprises a bipolar plate.

23. The electrochemical cell according to claim 20, wherein the electrochemical cell is a redox flow cell and the plate comprises an electrode.
